(19) United States
(12) Patent Application Publication
(10) Pub. No.: US 2011/0276451 A1
(43) Pub. Date: Nov. 10, 2011

(54) Motivational goal based interactive system and method

(76) Inventor: Frederick Anthony Busse, Hauppauge, NY (US)

(21) Appl. No.: 12/800,010

(22) Filed: May 6, 2010

(51) Int. Cl. G06Q 40/00; G06F 3/048

(52) U.S. Cl. 705/35; 715/772

(57) ABSTRACT

A motivational goal based online interactive system and method for personal development comprising a single web page for easy access to a calendar, goal tracker, motivational quote, video, recommended motivational and inspirational books, tapes and other material. The system and method of the invention provides for a success tracker and individualized feedback to assist the client user in achieving both short term and long term goals.

### FIELD OF THE INVENTION

The present invention is generally related to personal development tools, methods, and systems. More particularly, the disclosure is related to an interactive online personal development web page that provides access to motivational and goal oriented tools to assist individuals to strive towards their highest potential.

### BACKGROUND OF THE INVENTION

All human kind are born with certain inalienable characteristics exemplified by our genetic makeup that are personal and unique. Some of us have the ability to tap into our innate potentials on our own while others of us need to be motivated to bring out the potential that is ingrained in us. Then, there are others who are hampered by destructive and harmful behavior and habits developed over years, preventing them from achieving their goals in life without outside intervention and rehabilitation.

The practice of using personal coaches and mentors to assist in overcoming obstacles whether physical or psychological to achieve one's goals and potential has been known since time immemorial. Watching and listening to motivational speakers either in person or on TV, radio, videos, DVDs, and related software have also been popular in more recent times. The advent of the internet and websites touting personal development programs has resulted in a migration from the traditional modes of seeking motivational help to these sites which in most cases may not be satisfactory or effective in replacing the traditional one on one coaches and motivational speakers.

Goal based educational systems with tailored feedback and personalized coaching has been described in a series of patents, U.S. Pat. No. 7,156,665, U.S. Pat. No. 7,089,222, U.S. Pat. No. 6,658,398, U.S. Pat. No. 6,493,690, and U.S. Pat. No. 6,073,127. These are directed to providing a cognitive educational experience in a simulated real world environment with dynamic feedback and individualized learning experiences and where navigation through the system is at a pace controlled by the learner.

Behavior modification systems and methods for stopping smoking, weight control, stress management etc., through the establishment of a customized regimen and delivery of customized messages to a person on a daily basis by means of the interne, email, facsimile etc., as described in U.S. Pat. No. 5,967,789; development of a behavior modification program, including an electronic meeting room and interactive group peer support sessions to achieve lifestyle changes necessary to maintain health or recover from medical procedures as in the system of U.S. Pat. No. 6,039,688; an interactive personal coaching system for individuals with weight loss concerns as described in U.S. Pat. No. 7,376,700; and a behavior modification system for modifying undesirable behavior patterns as described in U.S. Pat. No. 6,769,915 are well known in the art.

The aim of the present invention is to provide an interactive online system and method to motivate individuals to create and sustain short term and long term goals in everyday life. Unlike other interactive online systems that are directed to personal growth as described in U.S. Pat. No. 6,439,893, and others in the prior art, the system and method of the present invention, provides the features of motivation, feedback, goal tracking, and personal development tools and accessories capable of being viewed on a single, easy to access, web page.

### SUMMARY OF THE INVENTION

The objective of the present invention is to provide an easily accessible and interactive, motivational and goal based online system and method for individuals who are interested in personal development in their daily lives.

Another objective of the present invention is to provide personalized feedback and encouragement in meeting short term and long terms goals established by individuals in their quest for self improvement.

In an embodiment of the present invention, the client user of the invention, registers with the website of the present invention and provides information about occupation, marital status, hobbies, accomplishments, short term and long term goals they have set up towards improving the various areas of their personal lives as well as in their financial situations, saving money for future purchases etc. In this embodiment, the user client is presented with a single web page for registration as well as windows to input the preliminary as well as goal setting information.

In an exemplary embodiment of the present invention, the single web page of the present invention, provides the user client with a calendar to keep track of daily goal accomplishments and updating new ones. The calendar assists in keeping individuals focused and accountable for their set goals such as eating healthy, exercising, meditating, practicing an instrument, learning a language etc.

In yet another exemplary embodiment of the present invention, the system and method of the invention provides feedback to the client users in relation to the progress in their short term and long term goals and suggests ways to better accomplish their goals, or set new goals in areas of their lives that perhaps need improvement. The system and method of the present invention is designed to keep individuals focused, motivated, and on course with accomplishing their short term and long term goals and ultimately serves the same purpose as a personal coach.

Another embodiment of the invention provides a goal tracker feature that assists with keeping track of, for example, their weight, diets, savings, hours of exercise, sleep etc.

In yet another embodiment of the present invention, the single web page of the present invention provides the user client with a daily motivational and inspirational quote, motivational, inspirational videos, DVD's, CD's etc as well as personal development books and tapes recommendations.

Another embodiment of the invention provides a space on the single web page of the present invention for posting photographs and pictures of items the individual has set as goals he or she is striving for, such as the purchase of a car, house, boat etc.

In an exemplary embodiment of the present invention, the single web page of the invention can be sent via electronic mail to client users for easy access each morning so that the client can check on feedback, motivational quote for the day, update calendar entries, set goals for the day etc.

In another embodiment of the present invention, the single web page of the invention can be printed out and reviewed by individuals or the information pertaining to the motivational website sent to them in the form of a hard copy for those who have no access to a computer or who lack the appropriate computer skills to interactively engage with the website online.

These and other embodiments, features, advantages, and objectives of the present invention will become obvious to one skilled in the art through the attached figures, detailed description of the invention, and the appended claims.

### BRIEF DESCRIPTION OF THE DRAWINGS

FIG. 1 illustrates an overview of the exemplary embodiment of the present invention.

FIG. 2 shows a flow chart of an embodiment of the invention with the feedback module and the goal evaluation module.

FIG. 3 illustrates the relationship between the exemplary modules of the present invention.

### DETAILED DESCRIPTION OF THE INVENTION

The present invention relates to a system and method for personal development presented in an easily accessible interactive single web page.

The embodiments of the present invention facilitate the use of a single web page to set short term and long term goals for personal development and receive constructive individualized feedback on their daily progress in achieving those goals. In this respect, the embodiments of the invention serve the same purpose as a personal coach.

The single web page selectively and advantageously provides motivational and inspirational quotes and videos, recommends motivational and inspirational books, CD's, DVD's and other material as a means of encouragement to individuals who have a difficult time adhering to their goals. A calendar feature assists individuals to set daily goals and helps them stay focused and accountable for their goals. In addition, a goal tracker provides for entries of one's weight, hours spent on activities, personal finance etc. on a daily basis.

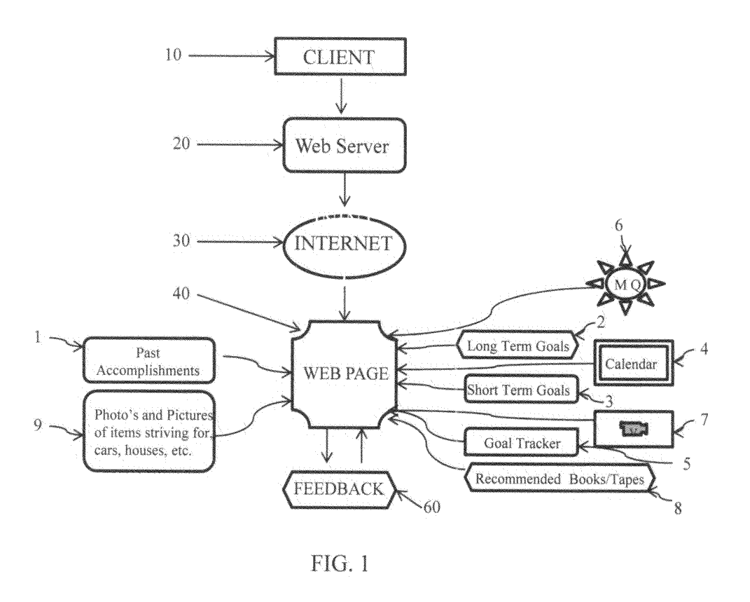

Referring now to FIG. 1, there is shown an overview of the exemplary embodiment of the present invention. Client user 10 accesses' the internet 30 through a web server 20 and is directed to the single web page 40 by means of the appropriate hyper text transfer protocol (HTTP). The client user 10 registers using a login and password and is then provided access to enter their profile and create a personalized web page. They are then presented with the calendar 4, goal tracker 5, motivational quote 6, motivational video 7, recommended motivational books/tapes 8 and appropriate spaces to enter their past accomplishments 1, photo's and pictures of items striving for 9. Feedback 60 is generated on a periodic basis and presented to the client user 10.

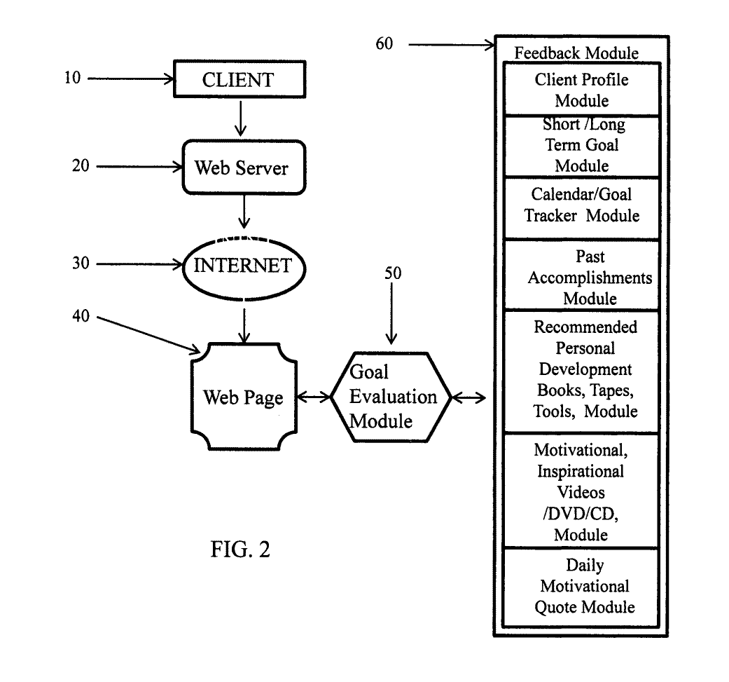

FIG. 2, illustrates a flow chart of the feedback module 60 generated after evaluation of the goals set and accomplished by the client user and evaluated by the goal evaluation module 50. The client user 10 enters their short term and long term goals in the appropriate windows on the web page and records their progress through the goal tracker and calendar. The feedback module includes feedback with appropriate recommendations of books, video's, CD's DVD's.

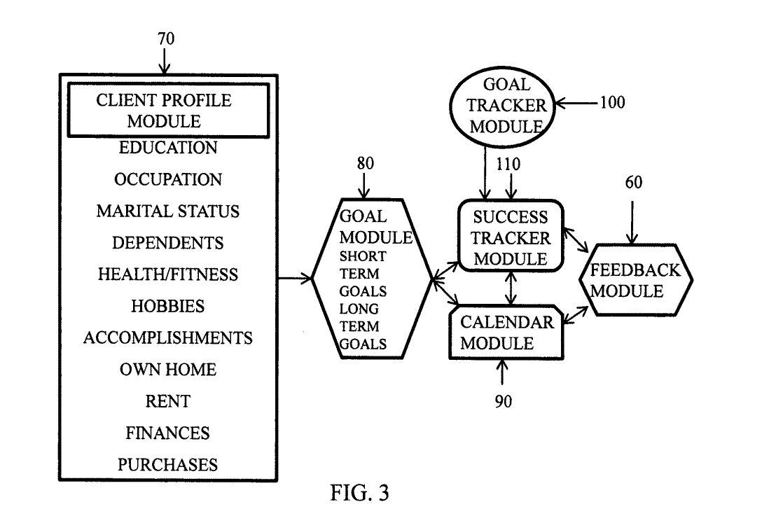

FIG. 3, illustrates the relationship between the exemplary embodiments of the present invention. The client user 10 creates a profile 70 module by entering relevant information such as education, occupation, marital status, dependents, health/fitness, hobbies, accomplishments, own home, rent, finances, purchases etc., and then sets up both short term and long term goals creating a goal module 80. The success tracker module 110 keeps track of the success in accomplishing the set goals, entries in the calendar module, 90 and goal tracker module 100. The feedback module 60 periodically generates feedback after taking into account the entries in the other modules.

The system and method of the present invention thus provides a personal development tool through an easy to access single online web page to assist individuals to stay motivated and focused on their short term and long term goals in life.

The system and method of the present invention and the preferred embodiments can also be communicated through hard copy to individuals who have no access to a computer and or lack computer skills to access the motivational website online.

The foregoing description of the invention through its figures and preferred embodiments should not be construed to limit the scope of the invention. It should be understood and obvious to one skilled in the art that the embodiments of the invention thus described may be further modified without departing from the spirit and scope of the invention as set forth in the claims that follow.

What is claimed is:

1. An interactive online personal development system, the system comprising:
a) A single web page;
b) means for creating a client user profile;
c) means for entering a plurality of personal short term and long term goals;
d) means for tracking progress of said personal short term and long term goals; and
e) means for providing feedback for said personal short term and long term goals;

2. An interactive online personal development system as in claim 1 wherein:
said means for creating said client user profile comprises registering and providing personal information and attributes selected from the group consisting of, education, occupation, marital status, dependents, health/fitness, hobbies, accomplishments, own home, rent, finances, purchases etc.

3. An interactive online personal development system as in claim 1 wherein:
said means for tracking progress of said personal short term and long term goals comprises a calendar.

4. An interactive online personal development system as in claim 1 wherein:
said means for tracking progress of said personal short term and long term goals comprises a goal tracker.

5. An interactive online personal development system of claim 1 wherein:
said means for providing said feedback is through a feedback module.

6. An interactive online personal development system of claim 1 wherein:
the said single webpage is sent via electronic mail to the user for easy access, to set goals for the day, access motivational quote, video and review feedback for progress in accomplishing set goals.

7. An interactive online personal development system of claim 1 wherein:
the said single webpage can be printed out for use or sent via hardcopy to recipients.

8. A method for providing an interactive online personal development tool for an individual, the method comprising the steps of:
client user registration;
client user profile creation;
client user short term and long term goal setting;
daily goal tracking;
daily calendar entry;
daily feedback generation; and
presenting, daily motivational quote and motivational video presentation.

9. The method of claim 8, wherein the client user profile creation comprises of personal information and attributes selected from the group consisting of, education, occupation, marital status, dependents, health/fitness, hobbies, accomplishments, own home, rent, finances, purchases etc.

10. The method of claim 8, wherein the said daily goal tracking comprises daily entries of progress for the said short term and long term goals.

11. The method of claim 8, wherein the said calendar entry comprises daily entries of activities and goals for the day.

12. The method of claim 8 wherein the said feedback generation comprises feedback for accomplishments on said short term and long term goals.

13. The method of claim 8, wherein the feedback is in the form of motivational quotes, books, videos and other such materials.

14. The method of claim 8 wherein the said feedback generation comprises feedback for accomplishments on said short term and long term goals and in the form of motivational quotes, books, videos and other such materials through a hard copy sent to recipients.
